(19) United States
(12) Patent Application Publication
(10) Pub. No.: US 2017/0012449 A1
(43) Pub. Date: Jan. 12, 2017

(54) Surface Mounted Device Charger

(71) Applicants: Teofilo Organista, Kennewick, WA (US); Isaac Organista, Kennewick, WA (US)

(72) Inventors: Teofilo Organista, Kennewick, WA (US); Isaac Organista, Kennewick, WA (US)

(21) Appl. No.: 14/793,610

(22) Filed: Jul. 7, 2015

(51) Int. Cl. H02J 7/00

(52) U.S. Cl. CPC H02J 7/0042

(57) ABSTRACT

A device includes a cord for connecting into a traditional alternating power supply. The device also includes retractable cords that can be returned and fit inside the device body when not in use. A mechanical or tactile feature on the body of the device or on the cords provides an indicator corresponding to a type of jack that matches the particular device to be charged. Other features are provided to the device to facilitate distinguishing of types of connectors available in the device. Users are able to quickly locate the power source, identify an appropriate cable, and commence charging while lingering near the device.

### BACKGROUND

Field

The present invention relates generally to an apparatus to charge or provide electric current to mobile devices and electronic peripherals.

Related Art

It is well known that mobile and wireless devices operate by a stored power source usually in the form of a battery. Typical batteries need to be recharged one or more times daily especially when put to heavy use throughout the day. Users often carry one and sometimes many of these devices. Users rely on these devices to conduct personal and professional business. For example, a typical businessman may carry several wireless devices that require varying amounts of power throughout the day. At any given time, the typical businessman may carry a watch, a wireless headset, a tablet, a laptop and one or more mobile phones.

Users are constantly seeking out opportunities to recharge their devices at work, at home, in their car, at the gym, in airports, restaurants and hotels. A common scene is someone sitting on the floor at a mall or airport next to a standard wall socket with his charger plugged into the socket and a wire plugged his device, pulling power like some vampire running low on life.

While there have been efforts made to provide power kiosks and charging stations, often users are responsible for providing their own cable. Such may be very inconvenient when considering substantial and daily use of such devices. Further, users may be required to carry several different power cords, and at worst, one for each device carried. In the case of some commercial power kiosks, the charge for using such service may exceed the budget of some users. While expensive commercial offerings may work in some circumstances, it does not fit the circumstances of the bulk of users. Accordingly, there remains a substantial opportunity to improve upon existing charging stations and to provide a charging device that can be installed near or formed in common structures and furniture in vehicles, at places of travel and at various locations of occupation.

### SUMMARY

Embodiments and techniques described herein relate to a non-obtrusive charging device that can provide power to recharge wireless electronic devices and provide power to wired devices. The device provides benefits and advantages not previously available in known devices.

In one particular illustrative implementation, a device includes a cord for connecting into a traditional alternating power supply. The device also includes retractable cords that can be returned to and fit inside the device body when not in use. A mechanical or tactile feature on the body of the device or on the cords provides an indicator corresponding to a type of jack or receptacle that matches the particular device to be charged. Users are able to quickly locate the power source, identify an appropriate cable, and commence charging while lingering near the device. The recharging device is inexpensive to manufacture and may be easily installed across a wide variety of existing locations thereby providing a substantial, inexpensive and convenient infrastructure for recharging devices in hotels, bus stops, restaurants, movie theaters, schools, automobiles, and so forth. A mechanism to accept micro payments is additionally provided so as to incentivize businesses, schools, government facilities and so forth to allow installation of the devices at many locations for the convenience of any device owner who spends at least a minimal amount of time at a stationary location.

This Summary is provided to introduce a selection of concepts in a simplified form that are further described below in the Detailed Description. This Summary is not intended to identify key or essential features of the claimed subject matter, and thus is not intended to be used to limit the scope of the claimed subject matter.

### BRIEF DESCRIPTION OF THE DRAWINGS

While the appended claims set forth the features of the invention with particularity, the invention, together with its objects and advantages, is more readily appreciated from the following detailed description, taken in conjunction with the accompanying drawings. Throughout, like numerals generally refer to like parts. Unless specifically indicated, the components and drawings are not shown to scale.

FIG. 1 illustrates a perspective view from a first direction of a table equipped with a device charger mounted underneath the working surface according to a first embodiment.

FIG. 2 illustrates a second perspective view of the table and other items shown in FIG. 1 from a direction substantially perpendicular to the direction of the view of FIG. 1 and illustrates the charging cables in a retracted configuration.

FIG. 3 illustrates a perspective view of the table of FIG. 1 as looking from underneath the table.

FIG. 4 is a closeup perspective view of a partially disassembled charging device according to a first embodiment and as shown in FIGS. 1-3.

FIG. 5 is a second closeup perspective view of the charging device shown in FIGS. 1-4 in another partially disassembled state.

FIG. 6 is a schematic diagram showing various electronic components of a charging device according to a second embodiment.

FIG. 7 illustrates a perspective view of a second embodiment of a power charger or device charger.

FIG. 8 illustrates a perspective view of a device charger according to a second embodiment.

### DETAILED DESCRIPTION

Overview. There is a substantial need for convenient and easy recharging of mobile devices. People increasingly carry, use and rely on mobile devices and have a concomitantly higher need to maintain power in these mobile devices. Currently, there is not a popular and widely distributed product that can be attached to and built into furniture and other locations where people naturally settle and live their life. People are often required to carry around their own cables and plug adapters/converters with the hope that they come across a free and accessible alternating current (AC) wall-mounted plug. Described herein is a device that solves many of the problems and shortcomings associated with charging or powering devices. The device is designed to be installed in a nonintrusive location such under a counter top or table and which includes a cable that is configured to provide direct current (DC) to portable devices.

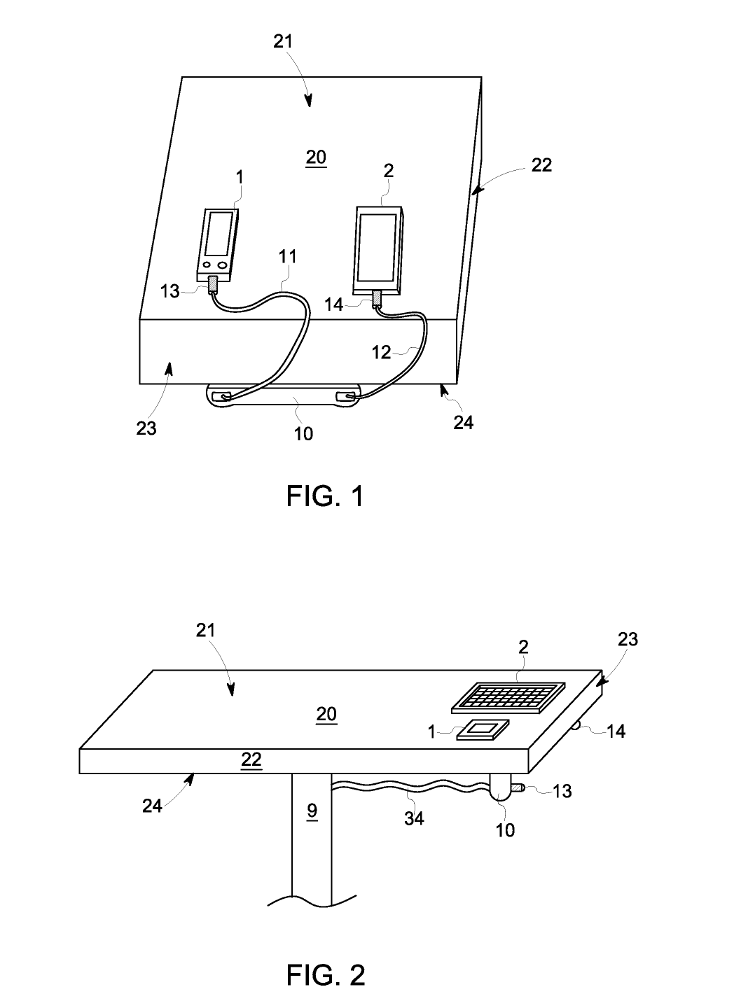

FIG. 1 illustrates a perspective view from a first direction of a table equipped with such a device—a device charger—mounted underneath the working surface according to a first embodiment. The overall device charger or power providing device is generally designated as 10 and is referred to herein as a charging device but it is understood that such device may be used equally well to continuously provide power to any type of electronic device. The table or location for mounting is generally designated as 20. With reference to FIG. 1, a mobile phone 1 and a slightly larger tablet computer 2 are resting on the surface 21 of the table 21 such as during a coffee break at a cafe. The table 20 has a lateral side 22, front side 23 and bottom side 24. According to the embodiment shown, the charging device 10 includes a first charging cable 11 and a second charging cable 12. The first charging cable 11 includes at its exposed or terminal end a plug or connector 13, which is typically a male type connector for engaging the electronic receptacle in the device 1. Likewise, the second charging cable 12 includes at its end a connector 14. The second connector 14 may be of a different style, shape, and so forth so as to offer power from the charging device 10 to a second device 2 that may be from a manufacturer different from the manufacturer of the first device 1. The first cable 11 and second cable 12 are retractable into the interior of the charging device 10 and thus may be stowed out for convenience when not in use. Thus, while a user (not shown) is waiting for coffee to be delivered to the table, a user may charge her devices 1, 2 and may then stow the cables 13, 14 out of the way when the coffee or food is delivered to the table 20.

FIG. 2 illustrates a second perspective view of the table and other items shown in FIG. 1 from a direction substantially perpendicular to the direction of the view of FIG. 1. With reference to FIG. 2, the charging cables have been retracted into the body of the charging device 10. The plugs 13, 14 are visible and proximate to the front side 23. What may not be immediately apparent is the location of the connectors 13, 14 relative to the front face or front side 23 of the table 20. In a preferred implementation, the charging device 10 is sized and formed so as to be susceptible to installation under a side 22, 23 of the table, proximate enough to be accessible by a user (not shown) and close enough to allow for easy extension of a charge cable. For example, once a first cable is extended, the connector 13 may be removably mated with the first device 1. The charging device 10 then provides power to the first device 1. A power cable 34 provides AC current to the charging device 10. Although not shown, a terminal end of the power cable 34 may be equipped with a standard AC plug for fitting into a standard AC socket. The table 20 is supported above the floor (not shown) by a post 9. Chairs (not shown) would then be placed proximate to the table 20 if the table 20 were part of the furniture in a coffee shop or restaurant. The charging device 10 alternatively may be installed in a variety of locations such as near hospital beds, airline seats, movie theatre seats, school desks and other locations where portable or mobile devices are likely to be encountered.

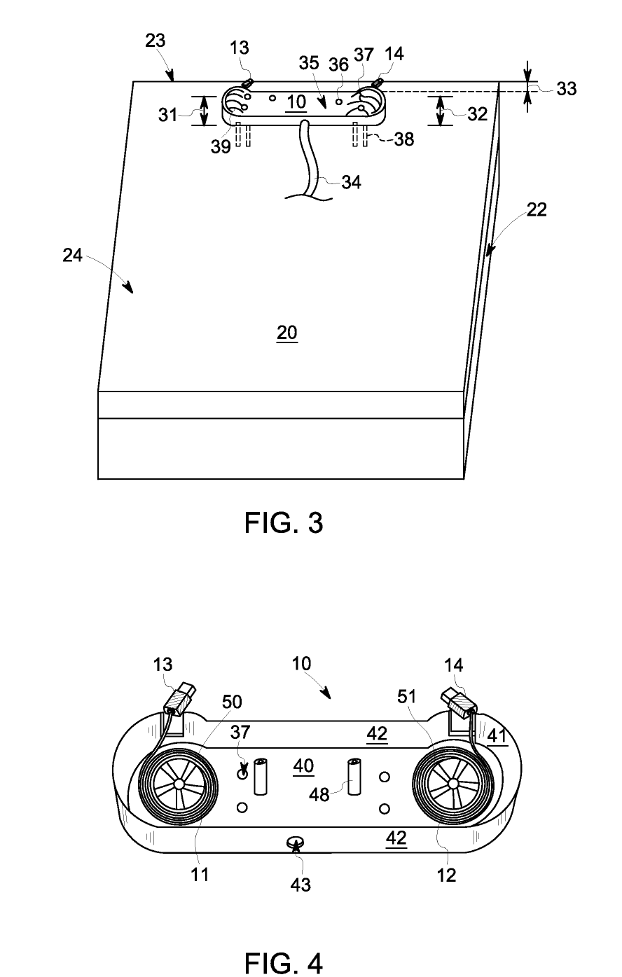

FIG. 3 illustrates another perspective view of the table 20 and charging device 10 first illustrated in FIG. 1 as looking from underneath the table. With reference to FIG. 3, the charging device 10 is mounted to the bottom surface 24 of the table 20. The table includes a lateral side 22 and a front side 23. The generally rectangular body of the charging device 10 is of a maximal height 31 and a maximal width 32. The size is at least enough to accommodate two charging cables and mechanical equipment to facilitate spooled and spring-loaded retraction of the charging cables when the charging cables are not in use.

The charging device 10 includes an exposed top surface 35 that is substantially planar for much of its width 32 and which runs substantially parallel or coplanar with the under side 24 of the table 20. The charging device 10 is mounted a recessed distance 33 away from a front side 23. The charging device 10 is preferably mounted substantially parallel with a front side 23 of the table considering an axis that runs along the length of the device 10 from left to right. Alternatively, the charging device 10 may be mounted in any location relative to the table 20 depending on one or more of a variety of factors not the least of which is convenience in accessing the plugs 13, 14 in view of table size, table geometry, room size and position of other furniture or other fixtures.

The length of the connectors 13, 14 is preferably less than the recessed distance 33 such that the connectors do not protrude beyond the side 23. The charging device 10 includes screws 36 or other attachment mechanism that secures a top portion of the charging device proximate to the rest of the body of the charging device 10. Recesses 37 are provided or formed in or through the body of the charging device 10 so as to facilitate use of mounting screws 38 that affix the charging device 10 to the table 20. An electrical cord 34 provides AC current to the device 10. Visible on the top surface 35 of the device 10 are contour features 39 showing that on each end of the charging device 10 there are contoured or shaped surface features formed in the charging device 10 as explained further herein with reference to other figures. The contour features 39 are implemented to facilitate distinction between types of plugs 13, 14 when the first plug or connector 13 is of a different size, shape or manufacturer than the second plug or connector 14.

FIG. 4 is a closeup perspective view of a partially disassembled charging device 10 according to a first embodiment and as shown in FIGS. 1-3. With reference to FIG. 4, the charging device 10 includes a flat or planar base 40. The base 40 mates against a surface such as the underside of a table (not shown) or other installed location. Many typical installation locations are likely to be substantially flat or planar, and accordingly a preferred form factor of the charging device 10 is flat on at least one of its sides.

On each lateral end of the charging device 10, there is a curved or arcuate side wall 41 that corresponds to the outer reaches of a spool which is generally denoted as circular or wheel-like element 50. A first cable 11 is wound around the spool 50 on a left side and a second cable 12 is would around a second spool 51 on the right side. While two spools 50, 51 are shown, one for each of the respective cables 11, 12, there may be any number of charge cables and spools in a charging device 10, and the size and shape of the device 10 would concomitantly be expanded to accommodate the necessary components. The spool 50 is shown exposed or opened for sake of illustration only. Ordinarily, when assembled, the spool 50 houses the first cable 11 inside of itself, and protects and maintains the first cable 11 from reaching other locations within the charging device 10.

Two charging cables 11, 12 are shown in the embodiment illustrated in FIG. 4 because generally there are two frequently encountered charging plug types—one type for Apple®-branded devices such as iPhones® and the like, and another type for mobile phones from other manufacturers. The charging device 10 also includes generally flat vertical side walls 42 that help enclose the device. A power cord aperture 43 is formed in one of the vertical side walls 42 for accepting a power cord (not shown in FIG. 4 for sake of simplicity of illustration). A pair of support posts 48 rise above the base 40 and receive mounting screws (not shown) that tightly hold a top plate (also not shown) onto the base 40 thereby forming an enclosure. The inside of the posts 48 are threaded. Apertures 37 are formed to accommodate the mounting screws 38 shown in FIG. 3.

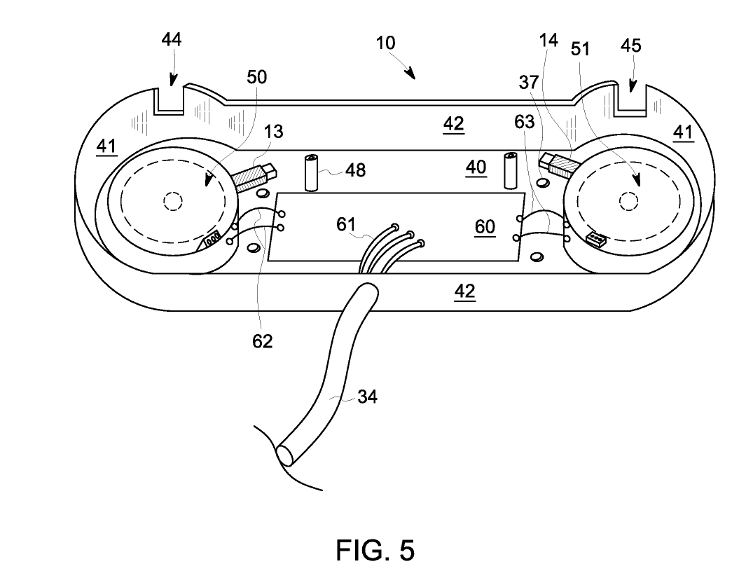

FIG. 5 is a second closeup perspective view of the charging device shown in FIGS. 1-4 in another partially disassembled state. With reference to FIG. 5, the base 40, curved walls 41, and side walls 42 are still visible. The posts 48 and apertures 37 are also still visible. The first spool 50 and second spool 51 are shown enclosed and fully assembled. The first plug or connector 13 is shown exposed outside of the spool 50 but not properly protruding through the window 44 formed in the arcuate wall 41. The second spool 51 is also shown enclosed and fully assembled. The second connector 14 is visible outside the body of the second spool 52. The second connector is not properly extended and is not protruding through the second window 45. The first window 44 and second window 45 are sized so as to allow or accommodate a cross section of the charging cable but smaller than the neck or collar of the first connector 13 and second connector 14, respectively. During assembly, the spring-loaded cables and connectors 13, 14 are extended outside through the windows 44, 45 and the top plate (not shown in FIG. 5) is mated to and fixed to the charging device 10 thereby trapping the connectors 13, 14 outside of the charging device 10 to facilitate proper use of the spools 50, 51 and spring-loaded charging cables.

The charging device 10 includes a circuit board 60 that provides, for example, an AC/DC conversion circuit for providing power to the charging cables. The circuit board 60 is in electrical communication with the AC power cord 34 via leads 61. Two pairs of outbound electrical leads 62, 63 extend to the spools 50, 51, respectively, for providing direct current (DC) to the charging cables. The first pair of electrical leads 62 may provide a first voltage that may be distinct or different from a second voltage provided through the second pair of electrical leads 63. Such different voltages are designated by and correspond properly to the expected voltages for the types of plugs 13, 14 provided by the charging device.

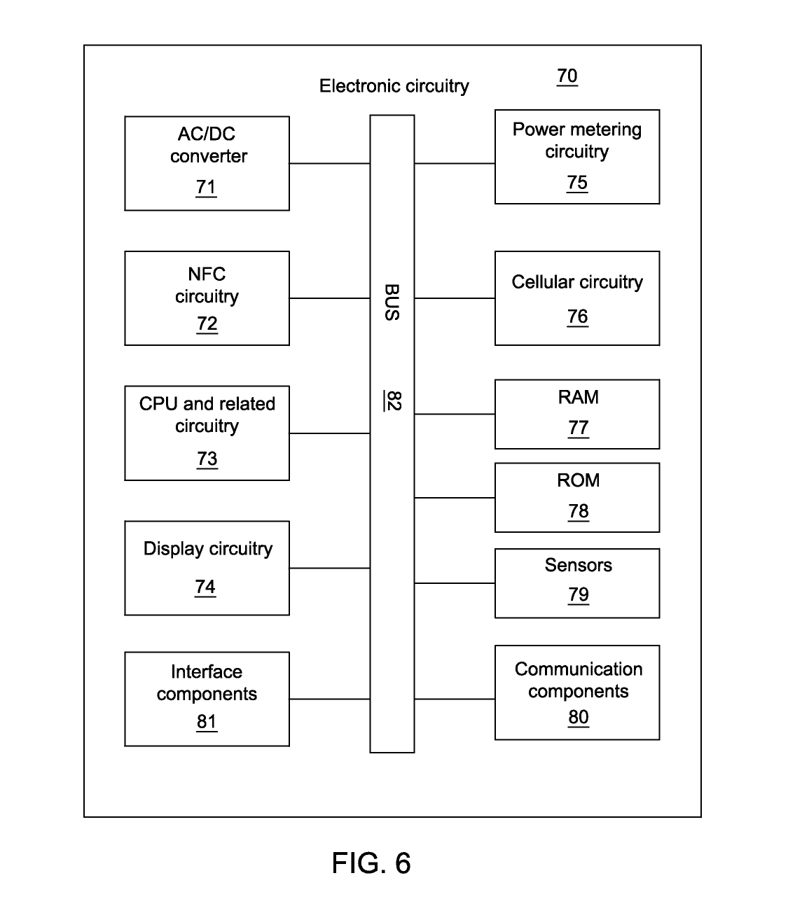

FIG. 6 is a schematic diagram showing various electronic components of a charging device according to a second embodiment. A single circuit board 60 was referenced in FIG. 5 for sake of simplicity with reference to a single function of converting AC to DC for providing power to the charging cords. As is understood in the art, such power conversion may be done with a single board or multiple components and/or with one or more circuit boards. With reference to FIG. 6, various other electronic circuitry 70 may be provided to a charging device 10 in addition to an AC/DC converter 71. For example, near field communication (NFC) circuitry 72 may be provided to the charging device 10. A general CPU and related circuitry 73 may also be provided. Components such as RAM 77, ROM 78 and display circuitry 74 may be provided and used in support of the use of the general CPU circuitry 73. More robust programming and intelligent interaction with the charging device 10 may thus be facilitated through use of an operating system and traditional programs and instructions. Further, power metering circuitry 75 may be provided. For certain applications, cellular telephone circuitry 76 may be provided. Finally, sensors 79, communications components 80 and interface components 81 may also be provided. Interface components 81 include such things as USB ports, video ports, audio jacks and so forth. All of these components 71-82 may be in electronic communication one with another through one or more buses such as the central bus 82 illustrated in this figure.

More detailed information and illustrative use cases are now presented for these components 71-82.

According to a first use case, a charging device 10 may be used in a most simple embodiment, that is, to act as a single function charger for charging a mobile phone. A user reaches for and extends a power cable from the device, and plugs it into her mobile phone for a period of time. At the end of the charging session, the user disconnects the charging cable, and with the aid of a spring-loaded spool such as spool 50, the user allows the charging cable to retract under tension back into the body or housing of the charging device.

According to a second use case, a charging device 10 is provided with an AC/DC converter 71, power metering circuitry 75 and NFC circuitry 72. When a mobile device that also has NFC circuitry enabled is brought sufficiently near the charging device 10, the mobile device and charging device 10 exchange information. For example, the mobile device receives information identifying the charging device 10 such as one or more of the following: (1) information identifying the owner of the charging device 10, (2) location information associated with the charging device 10, and (3) charging related information. Charging related information may include an amount of power provided to the device over a period of time as measured by the power metering circuitry 75 such as a during the time the mobile device is attached to the charging device 10. The electronic circuitry 70 may also receive information from the proximate mobile device such as a information related to charging such as voltage preferred by the mobile device. The charging device 10 may then provide power according to the information received from the mobile device. The NFC circuitry 72 may provide information to the mobile device once, intermittently over the course of time that the mobile device is proximate to the charging device 10, or at the beginning and end of a charging session.

According to a third use case, a charging device 10 is provided with an AC/DC converter 71, NFC circuitry 72, and communication components 80. Communication components 80 may include one or more of the following: (1) an audio-generating component such as a speaker or a tone generator; (2) a light generating component such as an LED, laser LCD panel, LED panel and the like; (3) a mechanical force generator such as a vibration generator or servo that can extend a charge cable; and (4) a thermal component such as a heater or cooler. According to this use case, When a mobile device that also has NFC circuitry enabled is brought sufficiently near the charging device 10, the mobile device and charging device 10 exchange information. For example, the mobile device provides to the charging device 10 information. Such information may include information related to a manufacturer, connector size, or a voltage requirement. In response, the charging device 10 may then actuate one of the communication components 80. For example, the charging device 10 may then respond to the transferred information by providing an audible signal on a left side or right side corresponding to the appropriate charging cable that matches the identity of the mobile device that has been placed proximate to the charging device 10. A user may then select the proper cable without having to guess which cable to use and without physically or visually inspecting which charge cable is appropriate for the mobile device.

Alternatively, still according to the third use case and actuation of another one of the communication components 80, the charging device 10 may then flash an appropriate LED on either a left side or right side corresponding to the appropriate charging cable that matches the identity of the mobile device that has been placed proximate to the charging device 10. The original signal is transferred via NFC communication components and triggers the communication component 80. The user may then select the proper cable and power connector matching the power receptacle of his mobile device by following a visible signal generated by the charging device 10. The user is then able to select without having to guess which cable to use and without physically or visually inspecting which charge cable is appropriate for the mobile device.

Alternatively, still according to the third use case and actuation of another one of the communication components 80, the charging device 10 may then activate a mechanical component on either a left side or right side corresponding to the appropriate charging cable that matches the identity of the mobile device that has been placed proximate to the charging device 10. The original signal is transferred via NFC communication components and triggers the communication component 80. The user may then reach out and touch either a left side or right side of the charging device 10 and locate and identify a side that is vibrating and thereby select the proper cable and power connector matching the power receptacle of his mobile device by following a mechanical signal generated by the charging device 10. The user is then able to select without having to guess which cable to use and without physically or visually inspecting which charge cable is appropriate for the mobile device.

According to yet another alternative, and still according to the third use case and actuation of yet another one of the communication components 80, the charging device 10 may then activate a thermal component (as a communication component 80) on either a left side or right side corresponding to the appropriate charging cable that matches the identity of the mobile device that has been placed proximate to the charging device 10. For example, the thermal component is a cooler that cools a portion of the outer surface of the charging device 10. Use of such thermal component would need to be balanced against the cost of producing the device. The original signal is transferred via NFC communication components and triggers the communication component 80 of the charging device 10. The user may then reach out and touch either a left side or right side of the charging device 10 and locate and identify a side that is blowing cold air and thereby select the proper cable and power connector matching the power receptacle of his mobile device by following a thermal signal generated by the charging device 10. The user is then able to select without having to guess which cable to use and without physically or visually inspecting which charge cable is appropriate for the mobile device. In these circumstances, the combination of NFC circuitry 72 and communication components 80 provide improved features as compared to known charging devices.

According to a fourth use case, a charging device 10 is provided with an AC/DC converter 71, NFC circuitry 72, power metering circuitry 75, and cellular circuitry 76. In this use case, when a mobile device that also has NFC circuitry enabled is brought sufficiently near the charging device 10, the mobile device and charging device 10 exchange information. For example, the charging device 10 may detect a new device in the vicinity and may then activate one or more portions of the cellular circuitry 76. The charging device 10 may receive via a NFC communication a type, a device size, a battery size, a manufacturer or other type of information from the mobile device. When the mobile device is attached to the charging cable, the power metering circuitry 75 may be engaged.

According to a first variation of the fourth use case, the charging device 10 may communicate, via a NFC transmission, information about charging to the mobile device. The charging information is preferably generated by the power metering circuitry 75. In such variation, the charging information may be a one-time or intermittent flow of information about an estimate of an amount of power being provided to the mobile device. Such estimate of power may be formed in one of several ways. According to a first example, the estimate is based on a time duration that the mobile device has been attached to the charging device 10 and is based on a fixed number (average of power consumed per unit of time) in a memory 77, 78 corresponding to an average of power consumed by charging the correspondingly identified mobile device (e.g., a mobile telephone of model X made by manufacturer ABC). Such average power number could be taken from manufacturer information and is pre-programmed into the memory 77, 78 of the charging device 10 at the time of manufacture of the charging device 10. In this way, the charging device 10 does not need to be dynamically configured or updated after initial manufacturer. According to another example, a second alternative calculation method, the power metering circuitry 75 could measure actual power consumption at each interval of time, then sum up the entire amount of power consumed over the charging period (time at which the mobile device is attached to the charging device 10), and finally communicate this information about the total power consumed during charging.

According to a second variation of the fourth use case, the charging device 10 may communicate, via a cellular transmission, information about charging to a third party server or service provider, or to the mobile device of the user. Such information about actual power consumed during charging could be used to request a micro-payment from a financial account associated with the mobile device that was charged. For example, for a twenty minute charge of a mobile phone, a user could be charged $0.35 at the end of a billing cycle, or within a few seconds of the power metering circuitry 75 detecting disconnection of the mobile phone from the charging device 10.

According to a fifth use case, a charging device 10 is provided with an AC/DC converter 71, NFC circuitry 72, sensors 79 and communication components 80. Sensors 79 may include such components as a proximity detector and a thermal detector for detecting if a human hand is brought sufficiently proximate to the charging device 10 such as when the charging device 10 is mounted under a table or for detecting movement proximate to one of the charge cables. According to this use case, when a mobile device that also has NFC circuitry enabled is brought sufficiently near the charging device 10, the mobile device and charging device 10 exchange information. For example, the charging device 10 may receive information from the mobile device via a NFC communication to identify which charging cable is appropriate for the mobile device. A communication component 80 may then activate, thereby directing a user of the mobile device to withdraw or unspool the appropriate charging cable from the charging device 10. For example, the communication component 80 may be an LED proximate to the window of the correspondingly appropriate charging cable and connector, and the charging device may flash the LED. When a user brings his hand close to the connector, a sensor 79 may then detect the proximity of the person's hand and causes the charging device to stop flashing the LED. In this way, the charging device 10 intelligently directs a user to select the appropriate charging cable. This use case and the other use cases described above are exemplary of the types of behaviors that are possible with the components illustrated in FIG. 6. Through such components, a variety of behaviors are possible for the charging device which improve upon known devices and methods for selecting an appropriate cable for a device to be attached to a charging device such as device 10.

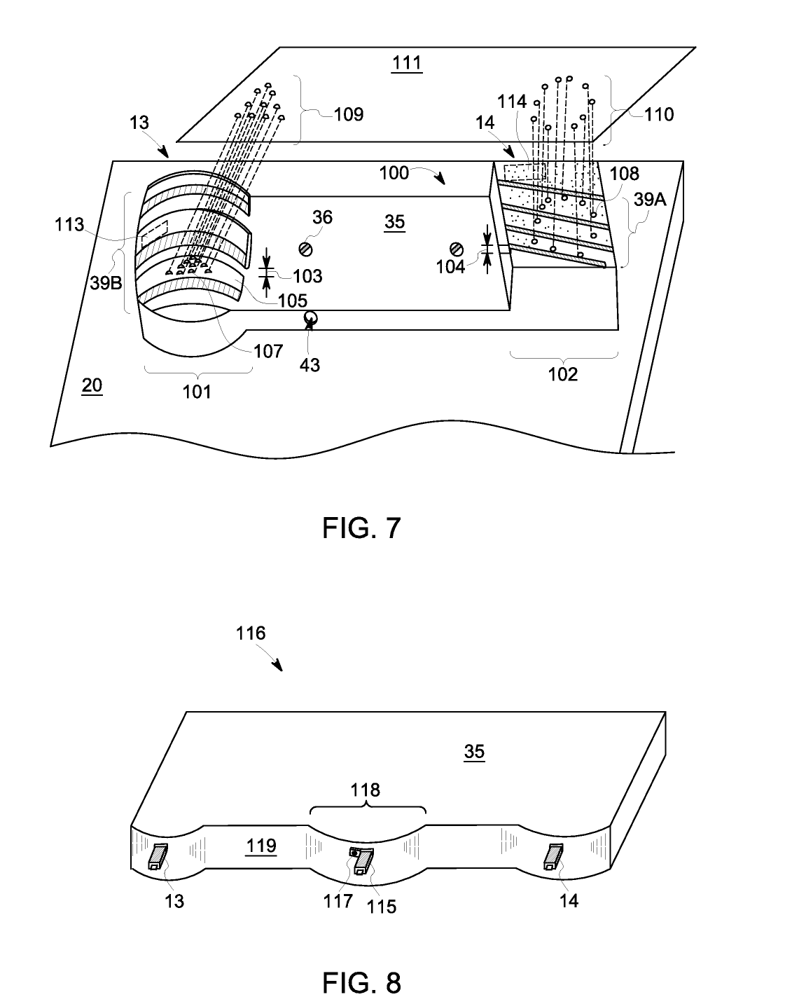

FIG. 7 illustrates a perspective view of a second embodiment of a power charger or device charger. With reference to FIG. 7, a charging device 100 is illustrated from a viewpoint similar to that of FIG. 3. The charging device 100 includes a first or left portion 101 inside of which is a first charging cable (with a connector 13 hidden by the body 35 of the charging device 100). The charging device 100 also includes a second or right portion 102 inside of which is a second charging cable coiled as illustrated in other figures such as FIGS. 4-5. Assembly screws 36 are visible on the top portion of the body 35. Just outside the right side 102 and hidden by the body of the charging device 100 is a second connector 14 as described in reference to other figures. The body 35 includes an aperture 43 for accepting an AC cord for providing AC power to the interior of the charging device 100.

The exterior of the charging device 100 has been adapted to provide physical contextual clues that distinguish the two types of charging cords inside of the device. The contextual clues have been accentuated in FIG. 7 to illustrate features to facilitate distinguishing of the two sides of the charging device 100 and thereby distinguishing between two charging connectors 13, 14, one of which would be incompatible for charging of any particular mobile device. Specifically, the right side 102 includes a first or rectilinear set of contour features 39A, and the left side 101 includes a rounded or ergonomic (second) set of contour features 39B. The first contour features 39A include narrow rectilinear valleys of a first narrow size 104. The second contour features 39B include distributed ridges 105 separated by valleys of a width 103 that is substantively larger than the first size 104. That is, a human user may tactilely be able to distinguish the left side 101 from the right side 102 based on this feature. Additionally, a depth of the respective sets of valleys may distinguish the left side 101 from the right side 102.

Further, the ridges, grooves and/or valleys as the second contour features 39B run along the rectilinear and raised portion 102 at an angle relative to the axis of the body 35 of the charging device 100. The ridges and grooves or valleys of the second set of contour features 39B run substantially parallel with the axis running along the body or top 35 of the charging device 100. A human user may tactilely be able to distinguish the left side 101 from the right side 102 based on this second feature.

Yet further, the left side 101 has been finished with a relatively smooth texture 113 as marked within an indicated dashed rectangular region. The right side 102 has been finished with a rough texture or stippled finish 114 within a second indicated dashed rectangular region. A human user may tactilely be able to distinguish the left side 101 from the right side 102 based on this feature.

Further, the left side 101 has been provisioned with a first set of visual communication components such as a first set of LEDs 107. The right side 102 has been provisioned with a second set of visual communication components such as a second set of LEDs 108. The color of light emanating from the first set of LEDs 107, although not illustratable in FIG. 7, may distinguish the left side 101 from the color of light emanating from the LEDs 108 of the right side 102. The two sides are yet furtherably distinguishable from each other based on the LEDs 107, 108. Specifically, the first set of LEDs 107 are arranged in a first pattern that is distinct from a second pattern in which the second set of LEDs 108 are arranged. When a paper or other incident surface 111 is place proximate to the LEDs 107, 108, the patterns 109, 110 of incident light from the LEDs 107, 108 are visible. In particular, the first pattern 109 is in the shape of a pyramid or triangle, and the second pattern 110 is in the shape of a circle. If a person were to place his hand under the table 20, and when one or both sets of LEDs 107, 108 were illuminated, the two sides could be distinguished by observing a pattern that emanates therefrom. The respective sets of LEDs 107, 108 may be formed into a letter, symbol or other actual symbol that corresponds to a manufacturer, size, number or other indicator associated with the corresponding connector 13, 14. In this way, a user is then able to select the appropriate connector 13, 14 without having to guess which cable (left or right) to use and without physically or visually inspecting which connector is appropriate for the mobile device. These features of the left side 101 and right side 102 provide enhanced features for a charging device 100.

FIG. 8 illustrates a perspective view of a device charger according to a second embodiment. With reference to FIG. 8, a device charger 116 includes a first plug 13 associated with a first vendor or type of charging receptacle, a second plug 14 associated with a second vendor or type of charging receptacle, and a third plug 115 such as corresponding to a USB-C type of plug. The third plug 115 is shaped so as to protrude and remain on the outside of the aperture 117 through which a charging cord attached to the third plug 115 may be extended for attaching to and charging an electronic device (not shown). The charging cord of the third charging plug 115 is attached to a spring loaded spool so as to facilitate retraction of the cord inside the body of the device charger 116. A contoured region 118 corresponding to the region at or near the third plug 115 is preferably distinguished from the regions corresponding to the first plug 13 and second plug 14. The contoured region 118 may include distinguishing features or contours along the front face 119 of the charging device 116 or on the top surface 35, or along both the front face 119 and top surface 35. This second embodiment illustrates that modifications to the charger may be made without departing from the purpose of the same and to allow for trends in the electronic device industry so as to support any number of types of devices and types of receiving charge receptacle corresponding to one of the plugs 13, 14 and 115.

Conclusion. In the previous description, for purposes of explanation, numerous specific details are set forth in order to provide an understanding of the invention. It will be apparent, however, to one skilled in the art that the invention can be practiced without these specific details. In other instances, structures, devices, systems and methods are shown only in block diagram form in order to avoid obscuring the invention.

Reference in this specification to “one embodiment”, “an embodiment”, or “implementation” means that a particular feature, structure, or characteristic described in connection with the embodiment or implementation is included in at least one embodiment or implementation of the invention. Appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

It will be evident that the various modification and changes can be made to these embodiments without departing from the broader spirit of the invention. In this technology, advancements are frequent and further advancements are not easily foreseen. The disclosed embodiments may be readily modifiable in arrangement and detail as facilitated by enabling technological advancements without departing from the principles of the present disclosure.

We claim:

1. A device for making available direct electrical current, the device comprising:
an electric cord for interfacing with an alternating current power source;
an AC/DC power converter in electronic connection with the electric cord;
a charging cord having a first end in electronic connection with the AC/DC power converter, and having a second end for electronically connecting to a second device, and wherein the second end of the charging cord includes a connector for matingly interfacing with a power receptacle of the second device;
a retracting spool onto which a length of the charging cord is wound; and
a housing formed with an aperture of a lateral dimension and a vertical dimension for providing passage of a portion of the charging cord in and out of the housing, and wherein the housing is formed with a tactile indicator that corresponds with the power receptacle of the second device so as to communicate a voltage requirement, a size, a shape or a manufacturer corresponding to that of a manufacturer of the second device.

2. The device of claim 1, and wherein the retracting spool includes an energy storing portion, and wherein the energy storing portion provides a biasing force which pulls the charging cord into the housing and onto the retracting spool.

3. The device of claim 1, and wherein the housing includes a flat portion for mating against another surface.

4. The device of claim 1, and wherein the charging cord includes a collar for engaging with the housing, and wherein the aperture of the housing is further formed so as to be small enough such that the collar engages the housing when the charging cord is gathered onto the retracting spool thereby preventing the second end of the charging cord from entering the housing, and wherein a width dimension of the collar is no more than four times the size of a cross-sectional width dimension of the charging cord.

5. The device of claim 1, and wherein a width dimension of the collar is less than three times the size of a cross-sectional width dimension of the charging cord.

6. The device of claim 1, and wherein the bottom surface of the housing is contoured into an ovoid shape over a region proximate to the retracting spool, and wherein the tactile indicator is formed on at least a portion of the surface of the ovoid shape.

7. The device of claim 1, and wherein the device further comprises: (1) a second charging cord having a first end in electronic connection with the AC/DC power converter, and having a second end for electronically connecting to a third device, and wherein the second end of the second charging cord includes a connector for matingly interfacing with a power receptacle of the third device; and (2) a second retracting spool onto which a length of the second charging cord is wound; and wherein the housing is formed with a second aperture of a lateral dimension and a vertical dimension for providing passage of a portion of the second charging cord in and out of the housing, and wherein the housing is formed with a second tactile indicator that corresponds with the power receptacle of the third device so as to communicate a voltage requirement, a size, a shape or a manufacturer corresponding to that of a manufacturer of the second device.

8. The device of claim 1, and wherein the device further comprises:
a near field communication (NFC) circuit for exchanging information between the device and the second device when the second device is placed proximate to the NFC circuit; and
a power metering circuit in electronic communication with the AC/DC power converter and with the NFC circuit.

9. The device of claim 8, and wherein the NFC circuit operates in either a NFC card emulation mode or a NFC peer to peer (P2P) mode.

10. The device of claim 1, and wherein the charging cord includes a colored indicator that corresponds to and communicates to an observer a voltage requirement, a size, a shape or a type of device compatible with a voltage of current provided by the charging cord and compatible with a shape of the connector.

11. The device of claim 1, and wherein the housing includes an illuminated and colored indicator positionally located for association with the charging cord, and wherein the illuminated and colored indicator corresponds to a voltage, a size, a shape or a manufacturer corresponding to that of a manufacturer of the second device.

12. The device of claim 1, and wherein the housing includes a set of illuminatable indicators arranged according to a shape that is associated with a voltage, a size, a shape or a manufacturer corresponding to that of a manufacturer of the second device.
